(19) United States
(12) Patent Application Publication
(10) Pub. No.: US 2008/0021589 A1
(43) Pub. Date: Jan. 24, 2008

(54) System for the exchange of information between a machining apparatus and a transfer device

(75) Inventor: Bruno Sandmeier, Seengen (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Erowa AG, Reinach (CH)

(21) Appl. No.: 11/825,928

(22) Filed: Jul. 10, 2007

(30) Foreign Application Priority Data
Jul. 18, 2006 (CH) 01157/06

(51) Int. Cl. G05B 19/18; G05B 19/04

(52) U.S. Cl. 700/159; 700/112; 700/114; 700/169; 318/568.2

(57) ABSTRACT

In a system for an exchange of information between a machine tool (1) and a transfer device (11) for feeding blank or pre-machined work pieces or tools to the machine tool (1) or removing machined products or tools from the machine tool (1), the machine tool (1) comprises a control unit (3) and an interface (4), whereby the control unit (3) monitors and controls machining states of the machine tool (1) and transmits information regarding the machining states of the machine tool (1) via the interface (4) to the transfer device (11) to activate the transfer device (11). The transfer device (11) receives the information via an interface (14) assigned to it, processes the information by means of a control unit (13) assigned to it and reacts in response to the information, whereby a printer interface is used as the interface (4) of the machine tool (1).

### BACKGROUND

The present invention relates to a system for the exchange of information between a machining apparatus, as for example a lathe, a milling machine, a spark erosion machine, a wire erosion machine or the like, and a transfer device, as for example a robot, for delivering not yet machined (blank) or partially machined work pieces or tools to the machining apparatus, or to remove machined work pieces or tools from the machining apparatus. A transfer device is used particularly in the case if a mass production is not possible, i.e., in manufacturing small quantities of machined products, whereby often different pieces have to be machined, requiring particular tools for their machining.

A transfer device performs an exchange of work pieces and/or tools, whereby it must be ensured that the transfer device and the machining apparatus operate in concert insofar as their particular operation steps are synchronized. Both the machining apparatus and the transfer device are provided with a control unit for controlling their operating sequences, whereby the control unit of the machining apparatus controls the sequence of a machining operation. In order to ensure a reliable and correct cooperation of machining apparatus and transfer device, their particular control units have to perform an exchange of information and data, respectively. Such exchange of information can be performed in different ways. The transfer device can transmit information to the control unit of the machining apparatus via its control unit, or the machining apparatus can transmit information to the control unit of the transfer device. According to the transmitted information, subsequently a synchronization and a step-wise clocking of the machining apparatus and of the transfer device is performed. However, it is also possible to provide a superordinate system for the control of the machining apparatus and of the transfer device.

Herein, the case should be considered in which the machining apparatus, performing as a so-called master, transmits information to the transfer device in response to machining steps that have been performed by the machining apparatus to thereby activate the transfer device. This case will often occur in practice since there are many machining apparatuses already in practical use that are upgraded by the addition of a transfer device.

An exchange of information and a communication, respectively, between the control unit of the machining apparatus and the control unit of the transfer device is realized, usually, via particular interfaces of the machining apparatus and the transfer device. In order to ensure that a communication between the control units of the machining apparatus and of the transfer device takes place without problems, the particular interfaces have to be adapted to each other.

Patent document CH 681 397 A5 discloses a manufacturing assembly comprising numerically controlled machine tools and control units assigned thereto, whereby tools and work pieces are received in magazines. The tools and work pieces are mounted on uniform support members and are transferred to and from the machine tools by means of handling apparatuses (transfer devices). They are adapted to be clamped in a well defined position n the machine tools. The support members are provided with electronic storage media containing data for identifying the tools and work pieces and for controlling the machining operation in the machine tools. The data contained in the storage media can be read by data processing units which are part of handling apparatuses and which are operationally connected to the control units of the machine tools. A general interface is provided for communication between a machine tool and a handling apparatus. By means of this interface, the control unit can call up the designation of the required work piece, where after a transfer is performed. During the transfer, the data stored in the storage media and containing information for the further machining of the work piece are transferred to the control unit.

The document DE 39 38 950 A1 refers to a system for numerically controlled machining, comprising a group of NC machines connected to each other, whereby machining programs are exchanged between the NC machines in the system and are collectively used. Assigned to the NC machines are data transfer interfaces, for example in the form of an RS-232C interface, for communicating with and thereby transferring data to and from an external device. By means of these interfaces, program loading requests are transmitted from one NC machine to the other NC machine, with the result that a requested machining program is extracted from a storage media and fed to a selected NC machine. This document does not refer to the transfer of work pieces and/or tools, but to the transfer of machining programs between NC machines.

The document DE 43 23 950 A1 refers to a method and an apparatus for controlling movements and/or processes of a tool that is moved along a predetermined path by means of a manipulator. The movements and/or processes are synchronously controlled by a function generator and superimposed to the feed motion along a path. The functions of the movements and/or processes are entered in function sections of the same or at least proportional size and are stored at least partially. After the initialization, a repeated cyclical execution of the function sections is performed synchronously. The function sections are calculated on the basis of parameters that are kept in storage at least for the period of a function section. Thus, this document refers to the synchronization of movements and/or processes of a tool during a machining operation.

The document WO 98/44399 A2 refers to a method of programming a safety-oriented control system, whereby safety-oriented control rules for linking input signals and output signals in the form of software macros are stored in a station of the control system. Instructions are transmitted to the station by a programming device, by means of which command sequences contained in the macros for assigning input and output information are recalled. Thus, this document discloses the use of macros with regard to a (general) control unit.

The document U.S. Pat. No. 6,145,020 A refers to a micro control unit. Thereby, the use of printer interfaces as preferred interfaces (serial and parallel; Centronics and RS-232C and RS-449) for connecting peripheral (control) devices to the micro control unit is suggested.

### SUMMARY OF THE INVENTION

It is one object of the invention to provide a system for exchange of information between a machine tool and a transfer device in which the exchange of information can be performed without difficulties and which allows a subsequent upgrade of a machine tool with a transfer device without considerable effort. Particularly, an activation of a transfer device shall be possible in manner as easy as possible, even in the case of upgrading of a machine tool.

According to one embodiment of the invention, a system for an exchange of information between a machine tool and a transfer device for feeding blank or pre-machined work pieces or tools to the machine tool or for removing machined products or tools from the machine tool is disclosed. The machine tool comprises a control unit and an interface, whereby the control unit monitors and controls machining states of the machine tool and transmits information regarding the machining states of the machine tool via the interface to the transfer device to activate the transfer device. The transfer device receives the information via an interface assigned to it and processing the information by means of a control unit assigned to it and reacting in response to the information. An interface of the machine tool, particularly a printer interface, may be used. Such an interface for connecting a printer is normally provided in machine tools for printing protocols or process data; thus, if a machine tool is upgraded by adding a transfer device, this interface can be used without further expenditure to feed information to the transfer device for activation thereof.

According to one feature of the invention, an interface of the control unit of the machine tool provided for a printer is used for “printing” and issuing, respectively, instruction. The programming of an existing interface can be performed by means of ISO code. At the end of the transfer device, an activation of a corresponding predetermined protocol is initiated. Such an interface is advantageously independent of the number of positions for pieces to be transferred. The interface can be a serial printer interface, particularly a RS-232/422 interface, or a parallel printer interface, particularly a Centronics interface.

The information regarding the status of machining by the machine tool advantageously comprises a transfer instruction for a work piece and/or a tool. Such a transfer instruction preferably comprises a magazine location number and a positioning location for the work piece and/or the tool, and/or a pivoting action for the transfer device. Such an information includes the information which is required for the exchange of parts at the machine tool.

Particularly, in the system according to one embodiment of the invention, additionally a synchronization means is provided for synchronizing and step-wise clocking the machine tool and the transfer device. This synchronization means preferably comprises, in each case, digital inputs/outputs of the machine tool and the transfer device. Particularly, the synchronization means is also used for feeding back a handshaking in response to a sent out information and a sent out transfer instruction, respectively; this is required because the printer interface is unidirectional. Similar to the printer interface, digital inputs/outputs normally are already present in machine tools and allow that signals from the control unit are sent out or read in into it.

An initialization of the printer interface of the machine tool is performed preferably by loading a macro for issuing the information to the transfer device; the control unit of the transfer device reacts, upon receiving the information, by activating a corresponding protocol. As has been previously mentioned, loading a macro can be performed easily by an operator of a machine tool by means of programming the appropriate ISO code.

Particularly, the transfer device performs an exchange of the work piece or the tool in response to its control unit having received an exchange instruction from the printer interface of the machine tool.

Moreover, it can be provided that the machine tool signalizes the readiness for an exchange of a work piece and/or of a tool by sending a corresponding signal to its digital output; this signal is fed to the digital input of the transfer device and is reset as soon as the machine tool no longer is ready for an exchange. However, it can also be provided that the control unit of the machine tool creates a cyclically repeated signal requesting a work piece or tool exchange which is sent to the printer interface. By these characteristics, it is ensured that the exchange instruction is cleared as soon as the machine tool is no longer ready for a work piece or tool exchange. Thereby, the safety for the machine tool and also for the transfer device is raised.

Preferably, the control unit of the machine tool sends out an exchange signal together with a check sum to the printer interface. By this check sum, the data integrity of the transmitted information is ensured.

At one side of the machine tool, there is provided a control rack comprising the control unit, the printer interface and the digital inputs/outputs of the machine tool. At one side of the transfer device, there is provided a control rack comprising the control unit, the printer interface and the digital inputs/outputs of the transfer device. Thereby, the control rack of the machine tool and the control rack of the transfer device preferably form a single unit that may be an add-on of the machine tool or of the transfer device; however, it could also be built-in into the machine tool or the transfer device, or it could be a separate, free standing rack.

The aforementioned as well as further characteristics and details of the invention will be even more apparent to a person skilled in the art from the following detailed description and the appended drawings, which represent characteristics of the present invention with the help of an example; thereby, in the drawings,

### DESCRIPTION OF THE FIGURES

FIG. 1 shows a block diagram of the system according to the invention with a machine tool and a transfer device; and

FIG. 2 shows a flow diagram for explaining the operation of the system according to the present invention shown in FIG. 1.

In the following, the present invention will be explained in detail with the help of a preferred embodiment and with reference to the accompanying drawings.

### DESCRIPTION OF THE ILLUSTRATED EMBODIMENTS

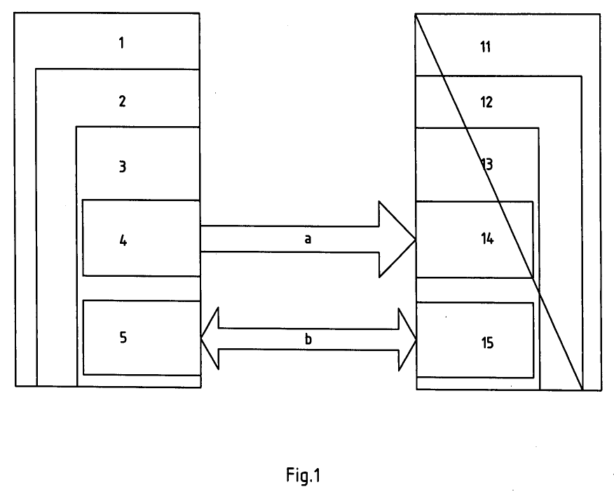

FIG. 1 shows a block diagram of a system according to one embodiment of the present invention. The system comprises a machine tool 1 and a transfer device 11. The machine tool 1 can be a lathe, a milling machine, a spark erosion machine, a wire erosion machine or the like. The transfer device 11 can be designed, for example, as a robot adapted to deliver blank work pieces or tools to the machine tool 1 or for removing machined work pieces or tools from the machine tool 1. Coordination between the machine tool 1 and the transfer device 11 is performed by means of an exchange of information between them.

An exchange of information between the machine tool and the transfer device can be realized by executing a sequence by means of a sequential interface. As such an interface, for example a profibus or a RS232/RS422 interface can be used, operating according to a certain protocol. Using a sequential interface has the advantage that a simple reliable connection may be realized and that there is no dependency on the number of positions for the loading of parts. However, thereby, it is required to adapt the software of the machine tool; this can be done often only by the manufacturer of the machine tool. Particularly in the case of machine tools that are already in practical use, an adaptation of the machine software is not readily possible or even not at all possible.

Moreover, there is the possibility to create logical bit patterns appearing at the digital outputs, which can be used by the transfer device for calculating a position. The creation of bit patterns, thereby, can be done by an operator by means of simple programming using an ISO code. However, it can happen that not enough digital outputs are available in already present machine tools, and sometimes it is not possible to add more digital outputs to a present machine tool. The number of the required digital outputs depends on the size of a storage area of the transfer device in which transmitted signals can be stored.

In the following, as an example, a simple embodiment of a communicating exchange of information between the machine tool and the transfer device is described which follows the teaching of the present invention.

As can be seen in FIG. 1, the machine tool 1 comprises a control rack 2 including a control unit 3, a serial or parallel printer interface 4 and digital inputs/outputs 5, while the transfer device 11 comprises a control rack 12 including a control unit 13, a serial or parallel interface 4 corresponding to the printer interface; and digital inputs/outputs 15. In practice, a single control rack 2, 12 both for the machine tool 1 and the transfer device 11 is provided, which is, as a rule, attached to or built into the machine tool 1 or the transfer device 11, or is free standing. However, in FIG. 1, a representation with separately shown control racks 2 and 12 has been chosen to clarify the assignment of the particular control units 3 and 13, interfaces 4 and 14 and digital inputs/outputs 5 and 15 (normally 24V) to the particular machine tool 1 and transfer device 11.

Further, the particular information or data streams a and b between the interfaces 4 and 14 and the digital inputs/outputs 5 and 15, respectively, can be seen.

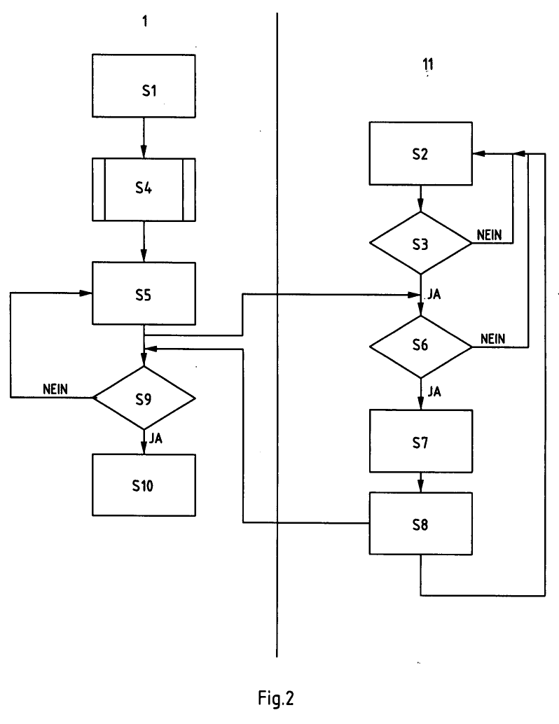

The information stream a runs unidirectionally from the printer interface 4 of the machine tool 1 to the interface 14 of the transfer device 11. It contains an instruction, being a printer instruction due to the fact that it originates from the printer interface 4, which requires that a piece, for example a work piece or a tool, of the machine tool has to be exchanged. This information, i.e., the exchange instruction a for the activation of the transfer device 11, is received via the interface 14 of the transfer device 11 by the control unit 13 of the transfer device 11 and causes the control unit 13 of the transfer device 11 to activate a protocol for performing different operation steps, as will be explained in more detail with reference to FIG. 2.

The information stream b runs in both directions between the digital inputs/outputs 5 of the machine tool 1 and the digital inputs/outputs 15 of the transfer device 11. It contains signals for the synchronization of the machine tool 1 with the transfer device 11, as will also be explained in more detail with reference to FIG. 2.

FIG. 2 shows a flow diagram for explaining the operation of the system according to the invention shown in FIG. 1. The flow diagram is subdivided into two parts, showing, in each case, the operations at the side of the machine tool 1 and at the side of the transfer device 11, respectively.

First, in a step S1, a system with a machine tool 1 and a transfer device 11 is activated. Thereby, an operator loads a special macro, normally an ISO code, into the control unit 3 of the machine tool 1. The result is that the control unit 13 can initiate, for example after the machining of a work piece has been finished, that the printer interface 4 can transmit a “print request”, i.e., the information a requesting the exchange of a work piece; the “print request” and information a, respectively, is transferred to the interface 14 of the transfer device 11. It is understood that the transmission of a “print request” a can take place also prior to machining a work piece in order to load a work piece to be machined into the machine tool 1. Moreover, a “print request” a can be created for loading or exchanging a tool.

Moreover, during step S1, connections are established between the machine tool 1 and the transfer device 11, particularly between the interfaces 4 and 14 as well as between the digital inputs/outputs 5 and 15. At the side of the transfer device 11, this is shown by a step S2, also showing a waiting state of the transfer device 11. At the side of the transfer device 11, in a step S3, it is checked whether or not the system has been established. Moreover, in this step S3, according to a later described second embodiment, it can be checked whether or not the machine tool 1 is in a state of readiness for an exchange of a work piece and/or a tool. If the result if the check is NO, a reset to the wait state in step S2 is performed. Otherwise, if the result of the check is YES, the program sequence at the side of the transfer device 11 proceeds to a step S6.

After the step S1 having finished at the side of the machine tool 1, the system is ready so that the machine tool 1 can be loaded by the transfer device 11, and at the side of the machine tool 1, the sequence proceeds to a step S4. In this step S4, a sub-program requesting an exchange is started by the control unit 3 of the machine tool 1, if such exchange is required at the side of the machine tool 1; such requirement is determined by the control unit 3 of the machine tool 1. Upon starting the above mentioned sub-program, the main program transfers for example the following parameters to the sub-program: The location identification of the work piece or tool in the magazine, a positioning identification, i.e., the information where the work piece or tool has to be placed, and possibly a description of the transfer movement to be performed by the transfer device. The sub-program having been started, the sequence at the side of the machine tool 1 continues to a step S5 in which the serial or parallel printer interface 4 sends a “print request”, as previously mentioned, to the serial or parallel interface 14 of the transfer device 11. Thereafter, the sequence at the side of the machine tool 1 continues to a step S9 in which the control unit is waiting for an acknowledgment of the exchange of a work piece or tool requested by sending out the “print request”.

Simultaneously, it is checked at the side of the transfer device 11 in a step S6 whether or not a “print request” has been received by the interface 14, and whether or not this “print request” is valid. The validity of the “print request” can be checked, for example, by transmitting the information in the “print request” together with a check sum. If the answer is NO in step S6, the sequence at the side of the transfer device 11 is reset to the waiting state in step S2. If, however, the answer in step S6 is YES, the sequence at the side of the transfer device 11 continues to a step S7, in which an exchange of the work piece or the tool is performed which has been initiated by the “print request” on the basis of the parameters transferred to the sub-program in step S3.

After the step S7, the sequence at the side of the transfer device 11 continues to a step S8 in which it is acknowledged that a work piece and/or a tool has been exchanged in the machine tool 1. Such acknowledgement is realized by means of sending a signal from a digital output 15 of the transfer device 11 to a digital input 5 of the machine tool 1 since the printer interface 4 of the machine tool 1 can transmit signals only in a direction from the machine tool 1 to the transfer device 11.

At the side of the transfer device 11, the sequence after step S8 returns to the waiting state in step S2, while at the side of the machine tool 1, a check is performed in step S9 whether or not an exchange of a work piece and/or tool has been acknowledged by the transfer device 11. If the answer is NO, the sequence at the side of the machine tool 1 returns, according to a first embodiment to be described later, to step S4 in which a “print request” is sent out, or, according to a second embodiment, the sequence is stopped to wait until the answer is YES. If the answer is YES, the sequence at the side of the machine tool 1 continues to a step S10 in which the machining program to be performed by the machine tool 1 is started; this means that the sub-program is left and the main program is resumed.

The first and second embodiments, which have been addressed above, relate to the case in which the machine tool 1 is not ready for an exchange of the work piece and/or tool. In this case, which is relevant for the reliable operation of the system, it is required that an exchange compellingly cannot take place; the result is that the “print request” and an exchange request, respectively, has to be canceled. This can be accomplished in one of two possible ways:

In a first embodiment, the “print request” can be cyclically repeated; according to the description herein above, this is the case if the answer in step S9, in which an acknowledgment of an exchange of a work piece and/or a tool is awaited, is NO.

In a second embodiment, for example after the sub-program in step S4 has been called, a signal can be sent to a digital output 5 of the machine tool 1 which indicates the readiness for an exchange. That signal, appearing at a digital input 15 of the transfer device 11, is recognized by the control unit 13 of the transfer device 11, as has been previously described in connection with step S3; this signal is temporarily stored or buffered by the control unit 13. In this case, only the receipt of an acknowledgement of the exchange of a work piece and/or tool has to be awaited in step S8; a repeated execution of step S6 is avoided. However, the signal for indicating the readiness for an exchange at the digital output 5 of the machine tool 1 has to be reset after an acknowledgment has been received that a work piece and/or a tool has been exchanged in step S8 (YES).

The sequence has been described above for a single exchange of a work piece and/or tool. According to the system of the invention, such an exchange can be performed, by simply initiating the sub-program, whenever a work piece has been finally machined by means of a machining program; thus, the main program (the machining program) and the sub-program are executed alternately.

According to the invention, it is easily possible to upgrade a machine tool with a transfer device and to coordinate them without the need to significantly modify the machine tool. It is only required to load a macro in order to enable the machine tool to transfer “exchange requests” to the transfer device to activate the latter.

What is claimed is:

1. A system for exchange of information between a machine tool (1) and a transfer device (11) for feeding blank or pre-machined work pieces or tools to the machine tool (1) or removing machined products or tools from the machine tool (1), wherein:
said machine tool (1) comprises a control unit (3) and an interface (4), said control unit (3) configured to monitor and control machining states of the machine tool (1) and to transmit information regarding the machining states of the machine tool (1) via said interface (4) to the transfer device (11) to activate the transfer device (11); and
said transfer device (11) is configured to receive said information via an interface (14) assigned thereto and to process said information by means of a control unit (13) to react in response to said information,
wherein a printer interface is used as the interface (4) of the machine tool (1).

2. A system according to claim 1, characterized in that the printer interface used as said interface (4) of said machine tool (1) is selected from a serial printer interface or a parallel printer interface.

3. A system according to claim 1, characterized in that said information regarding the machining states of said machine tool (1) includes an exchange request for a work piece and/or a tool associated with said machine tool (1).

4. A system according to claim 3, characterized in that the exchange request comprises a magazine location number and a positioning location for the work piece and/or tool and/or a pivot operation for the transfer device (11).

5. A system according to claim 1, further comprising a synchronization device (5, 15) that is configured for synchronizing and step-wise clocking the machine tool (1) and the transfer device (11).

6. A system according to claim 5, characterized in that said synchronization device (5, 15) includes digital inputs/outputs (5, 15) of aid machine tool (1) and said transfer device (11).

7. A system according to claim 1, characterized in that an initialization of said printer interface (4) of said machine tool (1) is realized by loading a macro for sending said information to said transfer device (11), and that said control unit (13) of said transfer device (11) is configured to activate a predetermined corresponding protocol in response to receiving said information.

8. A system according to claim 7, characterized in that said transfer device (11) performs, by means of said associated control unit (13), a work piece or tool exchange according to said protocol upon receiving an exchange request from said printer interface (4) of said machine tool (1).

9. A system according to claim 3, characterized in that said machine tool (1) indicates readiness for the exchange of a work piece and/or tool by providing a signal at said associated digital output (5), said signal being fed to said digital input (15) of said transfer device (11) and being reset, as soon as said machine tool (1) is no longer ready for an exchange.

10. A system according to claim 3, characterized in that said control unit (3) of said machine tool (1) is configured to cyclically repeat transmission of said exchange request to said printer interface (4).

11. A system according to claim 3, characterized in that said control unit (3) of said machine tool (1) is configured to transmit said exchange request with a check sum to said printer interface (4).

12. A system according to claim 6, characterized in that there is provided, at one side of said machine tool (1), a control rack (2) with said control unit (3), said printer interface (4) and said digital inputs/outputs (5), while, at one side of said transfer unit (11), there is provided a control rack (12) with said associated control unit (13), said printer interface (14) and said digital inputs/outputs (15).

13. A system according to claim 12, characterized in that said control rack (2) of said machine tool (1) and said control rack (12) of said transfer unit (11) form a single unit.
